(19) United States
(12) Patent Application Publication
(10) Pub. No.: US 2011/0175590 A1
(43) Pub. Date: Jul. 21, 2011

(54) ELECTRICAL POWER SUPPLY APPARATUS CONTROLLING METHOD AND DISCHARGING METHOD FOR USING THE SAME

(75) Inventors: Wei-Cheng YU, Tucheng City (TW); Yun-Chieh Hsu, Fuxing Township (TW)

(73) Assignees: SILITEK ELECTRONIC (GUANGZHOU) CO., LTD., Guangzhou (CN); LITE-ON TECHNOLOGY CORPORATION, Taipei City (TW)

(21) Appl. No.: 12/755,503

(22) Filed: Apr. 7, 2010

(30) Foreign Application Priority Data
Jan. 15, 2010 (CN) 201010019532.1

(51) Int. Cl. G05F 3/08

(52) U.S. Cl. 323/311

(57) ABSTRACT

Disclosed is an electrical power supply apparatus, comprising a switch circuit; an output circuit connected to an external power source for outputting electrical power primarily; a standby circuit connected to the external power source for outputting standby power; a discharge circuit connected between the output circuit and the external power source, to form a discharge path; and a control circuit, connected to the external power source, being capable of conducting the switch circuit for transferring a power signal of the external power source to the output circuit in a normal mode, being capable of cutting off the switch circuit for transferring a first or a second period of the power signal to the standby circuit in a standby mode, and being capable of conducting the discharge circuit for allowing the electrical power supply apparatus to discharge via the discharge circuit as the external power source is being removed.

### BACKGROUND OF THE INVENTION

1. Field of the Invention

The present invention relates to an electrical power supply apparatus, and more particularly, to a controlling method and a discharging method of an electrical power supplier in a standby operating mode.

2. Description of Related Art

With the advancement of technology in modern life, a variety of electronic devices providing various different functions are facilitated to accelerate the multimedia communication among people, e.g., a television, a computer, a workstation, a domain, etc., and also require a larger and more stable power supply quality correspondingly. A lot of daily activities are depending on computer equipments, e.g., work, game, communication, and data processing. Therefore, the computer equipments must be able to function steadily so as to facilitate people to use them. At present, conventional computer equipments generally include central processing units, i.e. CPU, chipsets, memory units, storage devices, interface connection devices, and electrical power supply. Herein, the electrical power supply is capable of providing electrical power with stable voltage, so that power signals provided from an external source, e.g. the public electrical power distribution system, convert to power signals with various voltage levels required by the computer's internal circuitry, e.g. +5V, +/−12V, or +3.3V, etc., to facilitate the stable operations of computer equipments.

When the computer equipments connect to the external power source, the computer equipments are able to function in a normal operating mode, a sleeping mode, a standby operating mode, or an off mode. Yet, to prevent the energy crisis and global warming phenomena from being more critical, a variety of different criteria are set by government organization for power consumption associated with different operating modes.

Specifications related to the power consumption trend are increasingly strict, for example, the European Union's (EU) Energy Using Products (EuP) Directive for computer equipments. The draft implementing measures for power consumption associated with internal power supply (IPS) of computer equipments in a standby mode, i.e. standby power consumption, were announced in October, 2008 at the third meeting of the EuP Directive. Herein, power consumption in a standby operating mode has made the following criteria: (1) From Jan. 7, 2010, power consumption in a standby mode must be less than 1 W; (2) From 2013, power consumption in a standby mode must be less than 0.5 W. In other words, power supply devices must be able to incorporate with backend plants under the condition that the minimum output current is around 50 mA to 60 mA to consume power less than 1 W or less than 0.5 W further. However, conventional power supply devices are unable to reach the harsh conditions.

Referring to FIG. 1, in which a system schematic diagram of a conventional power supply device is demonstrated.

Referring to FIG. 2, in which a curve diagram in accordance with power consumption of the conventional power supply device in a standby mode is demonstrated.

A conventional power supply device 1 includes a rectifying circuit 11, connected to an external power source 10 for receiving an external power signal and rectifying the external power signal to form a rectification signal; a power factor corrector 12, connected to the rectifying circuit 11, for receiving the rectification signal, correcting current harmonic distortion, and outputting a stable DC signal; an output circuit 13, connected to the power factor corrector 12, for receiving the DC signal and transforming the DC signal into various main power sources with different voltage levels to drive the computer equipments; additionally, a standby circuit 14, connected to the power factor corrector 12 and connected to the output circuit 13 in parallel, for transferring the DC signal to the standby circuit 14 as the output circuit 13 is shutting down, so that the computer equipments is able to maintain in a standby state by applying a minimum standby power consumption under a standby operating mode, e.g., 5V.

The strategy, adapted for low power consumption in accordance with the conventional power supply device 1 is to utilize a standby circuit 14 with lower power consumption to output a standby current under a standby operating mode, so that the computer equipments are able to enter in the standby mode and save power consumption came from output circuit 13. Yet by applying the above mentioned method, power consumption of the conventional power supply device 1 is unable to meet the strict specifications for power consumption. As shown in FIG. 2, as the operating current is at 50 mA to 60 mA, the power consumption is around 06 W to 0.7 W, such that it can't meet the requirements with respect to the EuP Directive in 2013.

### SUMMARY OF THE INVENTION

In view of the aforementioned issues, a embodiment according to the present invention provides an electrical power supply apparatus, comprising: a switch circuit; an output circuit, connected to an external power source by ways of the switch circuit, for outputting a main power source; a standby circuit, connected to the external circuit, for providing a supply of standby power; and a control circuit, connected to the external power source, for being capable of controlling the switch circuit to be in a conduction state for allowing a power signal of the external power source transferred to the output circuit in a normal operating mode, and controlling the switch circuit to be in a cutoff state for allowing a first period or a second period of the power signal transferred to the standby circuit in a standby operating mode.

In view of the aforementioned issues, a controlling method of an electrical power supply apparatus according to the present invention is provided. The method comprises the steps of: transferring a power signal to a output circuit if the electrical power supply apparatus is determined in a normal operating mode; and controlling a switch circuit by way of a control circuit if the electrical power supply apparatus is determined in a standby operating mode, such that a first period or a second period of the power signal is transferred to a standby circuit.

In view of the aforementioned issues, a discharging method of an electrical power supply apparatus according to the present invention is provided. The method comprises the steps of: determining whether an external power source is removed; and controlling a control circuit and conducting a discharge circuit connected to the external power source in parallel with respect to a simultaneously power signal as the external power source is being removed, such that a bulk capacitor connected to the external power source in parallel is discharged thru the discharge circuit.

The technique proposals according to the present invention are obviously different than the conventional technique, in which the controlling method and the discharging method in accordance with the electrical power supply apparatus in a standby operating mode are provided for achieving minimum power consumption and precisely controlling the discharging time of the bulk capacitor, such that the discharging time is not affected even if the standby power consumption is reduced, thereby enhancing stability of the electrical power supply apparatus. And the aforementioned controlling method, discharging method of the electrical power supply is obviously in conformity with the strict standards of the EuP Directive, to promote industrial upgrading.

In order to further understand the techniques, means and effects the present invention, the following detailed description and included drawings are hereby referred, such that, through which, the purposes, features and aspects of the present invention can be thoroughly and concretely appreciated; however, the included drawings are provided solely for reference and illustration, without any intention to be used for limiting the present invention.

### BRIEF DESCRIPTION OF THE DRAWINGS

FIG. 1 illustrates a system schematic diagram of a conventional power supply device;

FIG. 2 illustrates a curve diagram in accordance with power consumption of the conventional power supply device in a standby mode;

FIG. 3 illustrates a system schematic diagram of an embodiment of the electrical power supply apparatus in accordance with certain aspects of the present invention;

FIG. 4 illustrates a circuit diagram of the embodiment of the electrical power supply apparatus according to the present invention; and

FIG. 5 illustrates a curve diagram in accordance with power consumption of the electrical power supply apparatus in a standby mode according to the present invention.

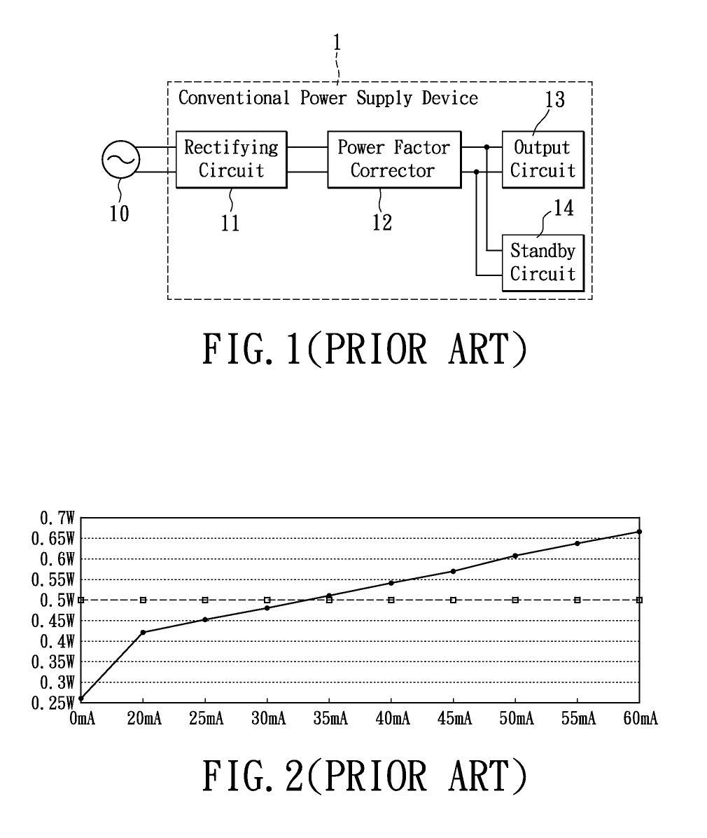

### DETAILED DESCRIPTION OF THE PREFERRED EMBODIMENTS

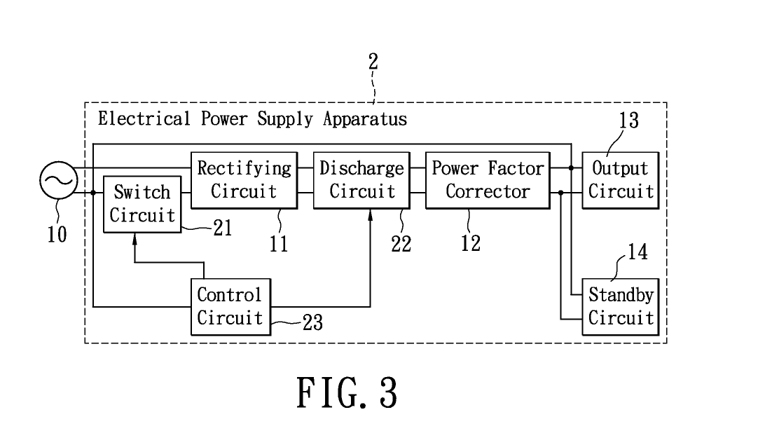

Please refer to FIG. 3, in which a system schematic diagram of an embodiment of the electrical power supply apparatus in accordance with certain aspects of the present invention is demonstrated.

An electrical power supply apparatus 2, includes a rectifying circuit 11, connected to an external power source 10 by way of a switch circuit 21, for receiving an external power signal of the external power source 10 and rectifying the external signal to generate a rectification signal. The switch circuit 21 is controlled by a control signal generated from a control circuit 23. In a normal operating mode, the switch circuit 21 conducts, such that the external power signal is transferred to an output circuit 13 by ways of the rectifying circuit 11, a discharge circuit 22, a power factor corrector 12. Herein, the switch circuit 21 and the discharge circuit 22 are controlled to be conducted with respect to the output circuit 13 or by means of the control circuit 23; in a standby operating mode, the switch circuit is cutoff, such that a first period or a second period of the external power signal transfers to a standby circuit 14; the power factor corrector 12, connected to the rectifying circuit 11, for receiving the rectification signal, correcting current harmonic distortion, and outputting a stable DC signal; the output circuit 13, connected to the power factor corrector 12, for receiving the DC signal and transforming various main power source with different voltage level to drive computer equipments.

The electrical power supply apparatus 2, further includes the standby circuit 14, connected with the power factor corrector 12 and also connected with the output circuit 13 in parallel. As the output circuit 13 is off, the DC signal is transferred to the standby circuit 14. The standby circuit 14 receives the DC signal and outputs a standby power, so that the computer equipments is able to maintain a stable voltage in the standby mode, thereby consuming a minimum power at the same time; the discharging circuit 22, connected between the rectifying circuit 11 and the power factor corrector 12, discharge a capacitive load of the electrical power supply apparatus 2 in response to a control signal; the control circuit 23, connected to a terminal of the external power source 10, generates a control signal to control the switch circuit 21 and the discharge circuit 22 in response to the power signal of the external power source 10. Therein, the rectifying circuit 11 may be a variety of different half-wave rectifier circuits or full-wave rectifier circuits. In the embodiment, a full bridge rectifier circuit is applied to perform full wave rectification of the external power signal.

A strategy to deduct power consumption of the electrical power supply apparatus 2 is shutting down the output circuit 13 and controlling the transformation of the external power signal by utilizing the conduction state or cutoff state of the switch circuit 21 in the standby operating mode. For example, the switch circuit 21 is applied to transfer the first period or the second period of the external power signal to the standby circuit 14 for preventing power consumption associated with the rectifying circuit 11, the discharge circuit 22, and the power factor corrector 12. Thus, a certain periods of the external power signal is used to provide merely a certain portion of the power signal to the standby circuit 14, so that the power consumption of the rectifying circuit 11, the discharge circuit 22, and the power factor corrector 12 is prevented, thereby reducing the overall power consumption of the whole electrical power supply apparatus 2. In the preferred embodiment, the first period of the external power signal is a positive half period and the second period of the external power signal is a negative half period, wherein the external power signal is an AC signal.

Additionally, because the electrical power supply apparatus 2 has a discharge circuit 22, as the external power source 10 is removed, the discharge circuit 22 is controlled to be conducted by the control circuit 23, so that charges stored in the capacitive load of the electrical power supply apparatus 2 are capable of discharging rapidly via a discharging path of the discharge circuit 22. Consequently, after the external power source 10 is removed, a charge storage capacity of the internal capacitive load in the electrical power supply apparatus 2 decreases rapidly, such that the power leakage current can be prevented and the discharging time can be controlled precisely.

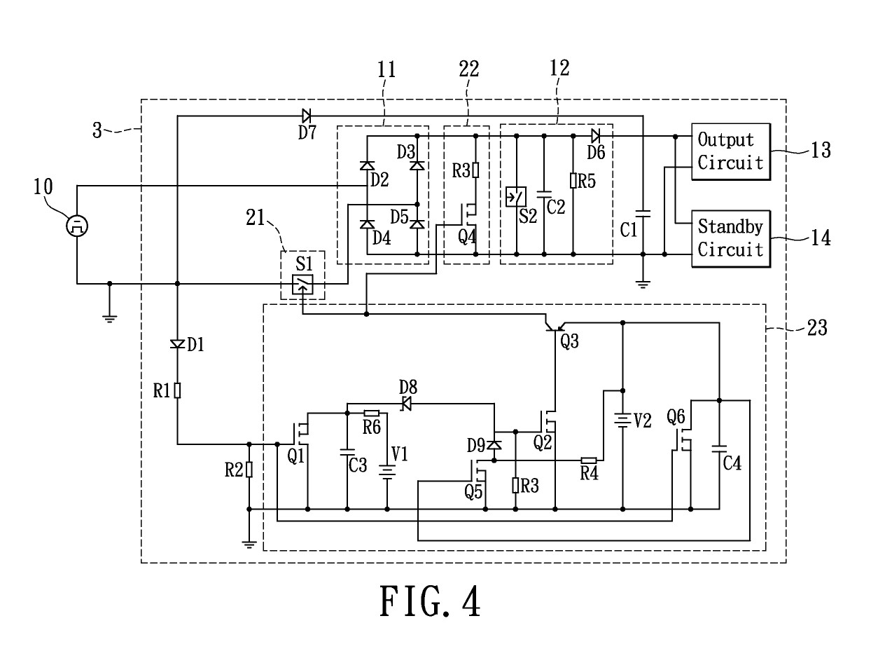

Next, please refer to FIG. 4, in which a circuit diagram of the embodiment of the electrical power supply apparatus according to the present invention is demonstrated.

The FIG. 4 is a circuitry design with respect to the embodiment of the electrical power supply apparatus as shown in FIG. 3. Herein, the rectifying circuit 11 is a full bridge rectifier circuit, being composed of four diodes D2˜D5; the switch circuit 21, is a switch S1 for demonstrated, but is not limited thereto; the power factor corrector 12, is composed of a capacitor C2, a resistor R5, a Diode D6, and a switch S2, wherein the switch S2 is controlled by a power factor correction chip (not shown); the output circuit 13 and the standby circuit 14 are respectively connected with the power factor corrector 12 and the output circuit 13 and the standby circuit 14 are connected in parallel, wherein the output circuit 13 and the standby circuit 14 are well known by the ones skilled in the art, therefore, merely connection relationship is shown herein; the discharge circuit 22, is composed of a resistor R3 and a fourth transistor Q4 in the embodiment, the fourth transistor Q4 conducts in response to a control signal of the control circuit 23, so as to discharge the capacitive load of the electrical power supply apparatus 3 thru the discharging path formed by the discharge circuit 22 rapidly; the control circuit 23, connected to a terminal of the external power source 10 by ways of a voltage divider circuit R1, R2, and a rectifying diode D1, controls the switch circuit 21 and the discharge circuit 22 in response to the external power signal.

Wherein, in the embodiment, the transistors Q1, Q2, Q4, Q5, and Q6 are NMOS transistors, and a third transistor Q3 is a PNP transistor, and the ones who are skilled in the art are capable of applying any other types of transistors, switches or circuits to replace the aforementioned transistors. Furthermore, the control circuit 23 and the switch circuit 21 may connect to any terminals of the external power source 10 so as to control the first period or the second period of the external power signal to transfer to the electrical power supply apparatus 2 according to the present invention.

While the computer equipments function in a normal operating mode, the electrical power supply apparatus 3 outputs a main power source to drive the computer equipments to function by means of the output circuit 13, wherein the main power source is either of or a combination of +5V, +/−12V, or +3.3V, etc., to facilitate the computer equipments to operate steadily; conversely, while the computer equipments are turned off or in a standby operating mode, the output circuit 13 of the electrical power supply apparatus 3 turns off and the standby circuit 14 outputs a standby power to maintain the computer equipments stability in the standby operating mode.

In the standby operating mode, the control circuit 23 receives the first period or the second period of the external power signal by means of the rectifying diode D1 and the voltage divider circuit R1 and R2. The gate-to-source voltages Vgs of the first transistor Q1 and the sixth transistor Q6 are greater than its threshold voltage Vth and then to be conducted, therefore, the gate-source voltage Vgs of the fifth transistor Q5 is less than its threshold voltage Vth and then to be cut off. Similarly, the gate-to-source voltage Vgs of the second transistor Q2 has the same voltage level as the drain voltage Vd of the first transistor Q1, and subsequently, the second transistor Q2 is cut off and then the third transistor Q3 is cut off too. Hence, in the standby operating mode, the switch S1 of the switch circuit 21 and the gate voltage Vg of the fourth transistor Q4 of the output circuit 22 are at low voltage level simultaneously. In order wards, they will be cut off at this operating mode.

Alternatively, while the electrical power supply apparatus 3 operates in the standby operating mode, the switch circuit 21 is cut off. In other words, the first period (positive half cycle) of the external power signal is in an open circuit loop in the electrical power supply apparatus 3. Thus, the first period of the external power signal is unable to be transferred to the electrical power supply apparatus 3; similarly, the second period (negative half cycle) of the external power signal is in a close circuit loop in the electrical power supply apparatus 3. Thus, the second period of the external power signal may be transferred to the electrical power supply apparatus 3 and may be transferred to the standby circuit 14 directly thru the path formed by the diode D7, so that the standby circuit 14 may generate the standby power. According to the present invention of the electrical power supply apparatus 3, there are no any power consumed by the rectifying circuit 11, the discharge circuit 22, the power factor corrector 12, and the output circuit 13 when the electrical power supply apparatus 3 operates in the standby operating mode. Moreover, the electrical power supply apparatus 3 merely transfers the second period of the external power signal to the standby circuit 14, such that the power consumption of the electrical power supply apparatus 3 is significantly reduced.

In addition, while a user removes the external power source 10, the internal stored power in the electrical power supply apparatus 3 must meet the second version of UL60950-1 safety requirements to be lower than 37% of the external power source 10 within one second after the external power source 10 is removed, for preventing leakage current issues happening. Consequently, a discharge circuit 22 according to the present invention is designed to be conducted after the external power source 10 is removed, so as to facilitate the capacitive load of the electrical power supply apparatus 3 to discharge rapidly thru the discharge circuit 22, and also meet safety requirement of the second version of UL60950-1.

Because the external power signal provided by the external power source 10 has the first period and the second period, the external power signal may be either in the first period or the second period as the external power source 10 is removed simultaneously. As such, it is necessary to design circuitry with respect to the first period or the second period respectively, so that no matter how the external power signal is suddenly cut off, the capacitive load can perform discharging by means of conducting the discharge circuit 22.

When the external power source 10 is removed and the external power signal is in the second period (negative half cycle), the gate-to-source voltage Vgs of the first transistor Q1 and the sixth transistor Q6 are not lower than the threshold voltage Vth simultaneously, such that the first transistor Q1 and the sixth transistor Q6 maintain for a period in the conduction state. Subsequently, the gate-source voltage Vgs of the fifth transistor Q5 is less than the threshold voltage Vth and is cut off in this moment. As a result, a second DC power source V2 may drive the gate-to-source voltage Vgs of the second transistor Q2 by a resistor R4 and a diode D9 to exceed the threshold voltage Vth, thereby conducting the second transistor Q2. Then the third transistor Q3 is conducted, such that the second DC power source V2 is transferred to the switch S1 of the switch circuit 21 and the fourth transistor Q4 of the discharge circuit 22, so that the switch S1 and the fourth transistor Q4 are conducted and the capacitive load of the electrical power supply apparatus 3 may perform discharging thru the discharging path which is composed of the resistor R3 and the fourth transistor Q4 of the discharge circuit 22.

While the external power source 10 is removed, and the external power signal is in the first period (positive half cycle), the gate-to-source voltage Vgs of the first transistor Q1 and the sixth transistor Q6 are lower than the threshold voltage Vth, such that the first transistor Q1 and the sixth transistor Q6 are cut off. Meanwhile, the fifth transistor Q5 is conducted. As a result, a first DC power source V1 may perform charging by ways of a resistor R6 and a capacitor C3 and drive the gate-to-source voltage Vgs of the second transistor Q2 by ways of a zener diode D8 to exceed the threshold voltage Vth, thereby conducting the second transistor Q2. Then the third transistor Q3 is conducted, such that the second DC power source V2 is transferred to the switch S1 of the switch circuit 21 and the fourth transistor Q4 of the discharge circuit 22, so that the switch circuit 21 and the discharge circuit 22 are conducted and the capacitive load of the electrical power supply apparatus 3 may perform discharging thru the discharging path which is composed of the resistor R3 and the fourth transistor Q4 of the discharge circuit 22.

Consequently, as per the aforementioned illustrations, as the external power source 10 is removed, no matter whether the external power signal is in either the first period or the second period, the discharge circuit 22 are conducted, such that the capacitive load of the electrical power supply apparatus 3 can discharge rapidly thru the discharging path generated by the discharge circuit 22. In the view of the embodiment according to the present invention, the built-in capacitive load of the electrical power supply apparatus 3 may discharge to be below 37% of the charge storage capability of the external power source within 300 ms. Thus, the provided technical proposal is not merely decreasing the power consumption in the standby operating mode, but also meets the second version of UL60950-1 standards with respect to the discharging time.

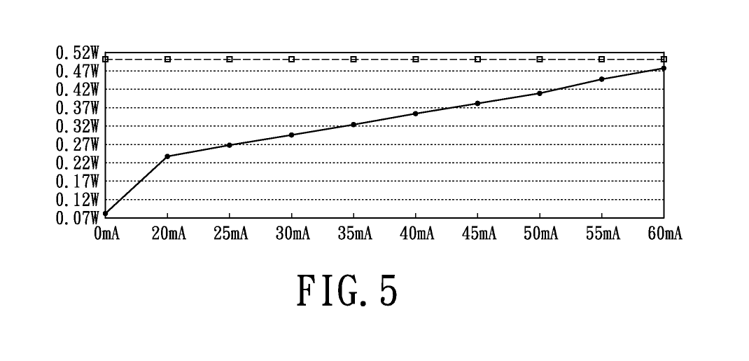

Finally, please refer to FIG. 5, in which a curve diagram in accordance with power consumption of the electrical power supply apparatus in a standby mode according to the present invention is demonstrated.

As per the aforementioned embodiment, while the electrical power supply apparatus 3 outputs a loading current around 50 mA to 60 mA in a standby operating mode, and the power consumption thereof is between 0.4 W to 0.48 W, the power consumption in accordance with the conventional power supply device 1 in the standby operating mode is significantly reduced, so that the electrical power supply apparatus 3 according to the present invention is capable of meeting the standards of EuP Directive 2013.

The aforementioned descriptions represent merely the preferred embodiment of the present invention, without any intention to limit the scope of the present invention thereto. Various equivalent changes, alterations, or modifications based on the claims of present invention are all consequently viewed as being embraced by the scope of the present invention.

What is claimed is:

1. An electrical power supply apparatus, comprising:
a switch circuit;
an output circuit, connected to an external power source by ways of the switch circuit, for outputting a supply of main power source;
a standby circuit, connected to the external circuit, for providing a supply of standby power source; and
a control circuit, connected to the external power source, for being capable of controlling the switch circuit to be in a conduction state for allowing a power signal of the external power source transferred to the output circuit in a normal operating mode, and being capable of controlling the switch circuit to be in a cutoff state for allowing a first period or a second period of the power signal transferred to the standby circuit in a standby operating mode.

2. The electrical power supply apparatus according to claim 1, wherein the control circuit, further includes:
a first transistor, connected to the external power source by way of a control terminal thereof, for being controlled by the power signal from the external power source;
a second transistor, connected to a first terminal of the first transistor by way of a control terminal thereof, for being cutting off in response to the conduction of the first transistor;
a third transistor, connected to a first terminal of the second transistor by way of a control terminal thereof, for being cutting off in response to the cutoff of the second transistor; and
a first DC power source, connected to a first terminal of the third transistor, for controlling the switch circuit by the third transistor.

3. The electrical power supply apparatus according to claim 2, further including a discharge circuit, connected between the output circuit and the external power source, for being capable of discharging a capacitor if the electrical power supply apparatus by means of controlling the discharge circuit to be in a conduction state by the control circuit as the external power source is being removed.

4. The electrical power supply apparatus according to claim 3, wherein the discharge circuit includes a fourth transistor and a resistor.

5. The electrical power supply apparatus according to claim 3, wherein if the external power signal is during the second period as the external power source is removed, the first transistor and a sixth transistor maintain in a conduction mode, a fifth transistor is in a cutoff mode, a second DC power source drives the second transistor to be conducted, and then the third transistor is conducted, such that the second DC power source drives the discharge circuit to be conducted by way of the third transistor.

6. The electrical power supply apparatus according to claim 3, wherein if the external power signal is during the first period as the external power source is removed, the first transistor and a sixth transistor are in a cutoff mode, a fifth transistor is in a conduction mode, a first DC power source drives the second transistor to be conducted, and then the third transistor is conducted, such that the first DC power source drives the discharge circuit to be conducted by way of the third transistor.

7. The electrical power supply apparatus according to claim 2, wherein the first period is a positive half cycle period, the second period is a negative half cycle period, and the external power signal is an AC power signal.

8. A controlling method of an electrical power supply apparatus, comprising the steps of:
transferring a power signal to a output circuit if the electrical power supply apparatus is determined in a normal operating mode; and
controlling a switch circuit by way of a control circuit if the electrical power supply apparatus is determined in a standby operating mode, such that a first period or a second period of the power signal is transferred to a standby circuit.

9. The controlling method according to claim 8, further including the steps of:
identifying if an external power source is removed, the control circuit conducts a discharge circuit, such that a capacitor connected with the standby circuit in parallel is discharged by means of the discharge circuit.

10. The controlling method according to claim 8, wherein the control circuit includes:
a first transistor, connected to an external power source by way of a control terminal thereof, for being controlled by the power signal from the external power source;
a second transistor, connected to a first terminal of the first transistor by way of a control terminal thereof, for being cutting off in response to the conduction of the first transistor;
a third transistor, connected to a first terminal of the second transistor by way of a control terminal thereof, for being cutting off in response to the cutoff of the second transistor; and
a first DC power source, connected to a first terminal of the third transistor, for controlling the switch circuit by the third transistor.

11. The controlling method according to claim 9, wherein the control circuit includes a fourth transistor and a resistor.

12. The controlling method according to claim 9, wherein if the external power signal is during the second period as the external power source is removed, the first transistor and a sixth transistor maintain in a conduction mode, a fifth transistor is in a cutoff mode, a second DC power source drives the second transistor to be conducted, and then the third transistor is conducted, such that the second DC power source drives the discharge circuit to be conducted by way of the third transistor.

13. The controlling method according to claim 9, wherein if the external power signal is during the first period as the external power source is removed, the first transistor and a sixth transistor are in a cutoff mode, a fifth transistor is in a conduction mode, a first DC power source drives the second transistor to be conducted, and then the third transistor is conducted, such that a second DC power source drives the discharge circuit to be conducted by way of the third transistor.

14. The controlling method according to claim 9, wherein the first period is a positive half cycle period, the second period is a negative half cycle period, and the external power signal is an AC power signal.

15. A discharging method of an electrical power supply apparatus, comprising the steps of:
determining whether an external power source is removed; and
controlling a control circuit and conducting a discharge circuit connected to the external power source in parallel with respect to a simultaneously power signal as the external power source is being removed, such that a capacitor connected to the external power source in parallel is discharged thru the discharge circuit.

16. The discharging method according to claim 15, wherein the control circuit includes:
a first transistor, connected to the external power source by way of a control terminal thereof, for being controlled by the power signal from the external power source;
a second transistor, connected to a first terminal of the first transistor by way of a control terminal thereof, for being cutting off in response to the conduction of the first transistor;
a third transistor, connected to a first terminal of the second transistor by way of a control terminal thereof, for being cutting off in response to the cutoff of the second transistor; and
a first DC power source, connected to a first terminal of the third transistor, for controlling the switch circuit by the third transistor.

17. The discharging method according to claim 15, wherein the discharge circuit includes a fourth transistor and a resistor.

18. The discharging method according to claim 15, wherein if the external power signal is during the second period as the external power source is removed, the first transistor and a sixth transistor maintain in a conduction mode, a fifth transistor is in a cutoff mode, a second DC power source drives the second transistor to be conducted, and then the third transistor is conducted, such that the second DC power source drives the discharge circuit to be conducted by way of the third transistor.

19. The discharging method according to claim 15, wherein if the external power signal is during the first period as the external power source is removed, the first transistor and a sixth transistor are in a cutoff mode, a fifth transistor is in a conduction mode, a first DC power source drives the second transistor to be conducted, and then the third transistor is conducted, such that a second DC power source drives the discharge circuit to be conducted by way of the third transistor.

20. The discharging method according to claim 15, wherein the first period is a positive half cycle period, the second period is a negative half cycle period, and the external power signal is an AC power signal.
